(19) United States
(12) Patent Application Publication
(10) Pub. No.: US 2009/0101005 A1
(43) Pub. Date: Apr. 23, 2009

(54) FREE-PISTON DEVICE AND METHOD FOR OPERATING A FREE-PISTON DEVICE

(75) Inventors: Sven-Erik Pohl, Tuebingen (DE); Cornelius Ferrari, Stuttgart (DE)

Correspondence Address: Muncy, Geissler, Olds & Lowe, PLLC, P.O. BOX 1364, FAIRFAX, VA, 22038-1364, US

(73) Assignee: UMC UNIVERSAL MOTOR CORPORATION GMBH, Stuttgart (DE)

(21) Appl. No.: 12/340,318

(22) Filed: Dec. 19, 2008

Related U.S. Application Data
(63) Continuation of application No. PCT/EP2007/055981, filed on Jun. 15, 2007.

(30) Foreign Application Priority Data
Jun. 20, 2006 (DE) 102006029532.3

(51) Int. Cl. F15B 15/14; F01B 29/00

(52) U.S. Cl. 92/85 B; 92/143

(57) ABSTRACT

There is provided a free-piston device, comprising at least one piston chamber in which at least one piston assembly is arranged for linear displacement, the at least one piston assembly being drivable under the action of a medium which expands in an expansion space, and the at least one piston chamber having a resilience space, in which a compressible gas is contained for exerting a returning force on the at least one piston assembly, and at which a control member is arranged for controlling the returning force while the free-piston device is in operation. A method for operating a free-piston device is also proposed.

This application is a continuation of international application number PCT/EP2007/055981 filed on Jun. 15, 2007.

The present disclosure relates to the subject matter disclosed in international application number PCT/EP2007/055981 of Jun. 15, 2007 and German application number 10 2006 029 532.3 of Jun. 20, 2006, which are incorporated herein by reference in their entirety and for all purposes.

### BACKGROUND OF THE INVENTION

The invention relates to a free-piston device, comprising at least one piston chamber in which at least one piston assembly is arranged for linear displacement, the at least one piston assembly being drivable under the action of a medium which expands in an expansion space, and the at least one piston chamber having a resilience space containing a compressible gas for exerting a returning force on the at least one piston assembly, and at least one control member for controlling the returning force, which is arranged at the resilience space.

The invention further relates to a method for operating a free-piston device, wherein at least one piston assembly guided for linear displacement in at least one piston chamber is driven under the action of a medium which expands in an expansion space, and wherein a returning force is exerted on the at least one piston assembly by a compressible gas contained in a resilience space of the at least one piston chamber.

Via a free-piston device, chemical energy, for example, can be partly converted by means of combustion into mechanical energy, namely kinetic energy of a piston device, and, in turn, this mechanical energy can then be converted via a linear drive at least partly into electric energy. Owing to configuration of the piston displacement as free-piston displacement, a pure linear displaceability of the pistons can be realized without a crankshaft having to be provided.

Corresponding devices can, for example, be used as part of hybrid drives for motor vehicles and, in particular, in conjunction with serial hybrid concepts. They can also be used as compact current-generating unit for generating current or in conjunction with stationary applications such as, for example, block-type thermal power stations.

Free-piston devices are known, for example, from GB 854,255 and from DE 22 17 194 C3.

Combustion devices with electric generators are also known from U.S. Pat. No. 6,199,519 B1, DE 31 03 432 A1, East German Patent No. 113 593, DE 43 44 915 A1 or from the article “ADVANCED INTERNAL COMBUSTION ENGINE RESEARCH” by P. Van Blarigan, Proceedings of the 2000 DOE Hydrogen Program Review.

There is known from DE 102 19 549 B4 a free-piston device with electric linear drive, comprising at least one piston chamber with at least one piston assembly arranged for linear displacement in the piston chamber, the piston assembly comprising an armature, and a stator device being arranged on the piston chamber. The at least one piston assembly is drivable under the action of a medium which expands in an expansion space, and the piston stroke is variably adjustable via the linear drive in such a way that the dead centers of the displacement of the piston assembly are definable.

A further free-piston device with electric linear drive is described in WO 01/45977 A2.

There is known from EP 1 398 863 A1 a free-piston device in which a first displacement space in which a piston of the at least one piston assembly, on which the medium acts, is movable, and a second displacement space in which the associated armature is movable, are separate spaces.

There is known from DE 197 81 913 T1 a method for controlling the movement of a linear generator, the linear generator being driven by an internal combustion engine with two pistons aligned in relation to each other on an axis and arranged opposite each other. The current intake is so controlled that during a reciprocation cycle of the generator a resistance force is obtained, which acts substantially proportionally on the generator at least in the central stroke movement range of the speed of movement of the generator. Pressure sensors are provided in the combustion chambers, and a control device triggers a mechanism to ignite the mixture supplied to the combustion chambers when a fixed pressure is reached.

A free-piston device with electric linear drive is known from DE 10 2004 062 440 B4. The free-piston device comprises a resilience space containing a gas. There is provided at the resilience space at least one pressure sensor, with which the position and/or the speed of the piston assembly can be determined by measuring the pressure of the gas in the resilience space. Via the measured pressure, the free-piston device can be controlled, for example, with regard to the injection of fuel into the expansion space and the point in time at which fuel is ignited in an expansion space and/or with regard to valves arranged at the expansion space.

### SUMMARY OF THE INVENTION

In accordance with the present invention, a free-piston device is provided, the free-piston device, in particular, the displacement of the at least one piston assembly in the at least one piston chamber, being adjustable in a simple way.

In accordance with an embodiment of the invention, the returning force is controllable while the free-piston device is in operation.

The gas contained in the resilience space can absorb at least partially mechanical energy of the (at least one) piston assembly by being compressed by the latter. Conversely, it can deliver energy to the at least one piston assembly by expansion, and thereby cause the at least one piston assembly to be returned via the returning force made available. During both the compression by the at least one piston assembly and the expansion, the gas contained in the resilience space exerts a force on the piston assembly, namely as a result of its own gas pressure. The force counteracts the compression by the piston assembly.

The resilience space with the gas contained therein, therefore, has resilient properties and, in particular, forms a gas spring, with the returning force being determined by the resilient properties of the resilience space. These are substantially determined by the way in which the gas is compressible by the piston assembly.

With the control member arranged at the resilience space, it is possible to control the returning force originating from the resilience space. Thus, the way in which the gas in the resilience space is compressible by the piston assembly can be influenced by the control member. The piston assembly can, therefore, be influenced in its displacement by the setting of the resilient properties of the resilience space. This allows the free-piston device to be adjusted in a simple way. It is thus possible to fix an optimum operating point for the free-piston device, at which, for example, the fuel requirement and/or the emission of pollutants is minimized. An adaptation of the free-piston device to various fuels is also conceivable.

The at least one control member can be constructed in various ways. For example, piston assemblies, flaps, control pins or the like are conceivable.

The control member itself can be controlled, for example, by a control device.

In accordance with the invention, the returning force is controllable while the free-piston device is in operation. In this way, the free-piston device is adjustable during operation. This allows the operating point of the free-piston device to be set without interrupting its operation. It may be provided that the controlling is carried out in accordance with a given operation chart. Such an operation chart can be stored in a control device. It is also possible for one or more characteristics relating to the momentary operating state of the free-piston device to be recorded during operation of the free-piston device, on the basis of which the controlling of the returning force is carried out.

The at least one control member is preferably movable. This allows the controlling of the returning force to be carried out in a constructionally simple way. For example, it may be provided that the at least one control member displaces the gas contained in the resilience space by its movement.

It is expedient for the at least one control member to be movable in a fixable manner, as this simplifies controlling of the returning force in accordance with requirements. For example, the at least one control member can be fixed when no change in the returning force is to take place. This also allows controlling in several steps and/or in steps of different size.

The at least one control member is preferably displaceable.

In particular, it may be provided that the direction of the displacement of the at least one control member is parallel to the direction of movement of the at least one piston assembly.

It is expedient for a drive to be associated with the at least one control member for movement thereof. This allows the at least one control member to be precisely moved and positioned by the drive. The drive may be a mechanical and/or pneumatic and/or hydraulic and/or electric drive.

The drive is preferably controllable. This makes it possible to provide the drive with a signal from outside and to bring about a defined movement of the at least one control member. For example, a control device may be provided for controlling the drive. The control device can control the drive according to a given operational plan or in dependence upon a signal fed to the control device from outside.

In an advantageous embodiment of the free-piston device according to the invention, at least one control member is formed as a wall section delimiting the resilience space. This constitutes a simple as well as robust way of forming a control member. The delimiting wall section may be arranged on the piston chamber, i. e., for example, on a wall area of the piston chamber. In particular, it is, however, possible for the delimiting wall section to be arranged in the interior of the at least one piston chamber.

It is expedient for the wall section to lie opposite an end face of the at least one piston chamber. The returning force can thereby be set in a constructionally simple way.

An embodiment in which the wall section is formed by a piston face is quite particularly preferred. A wall section configured in this way and, therefore, a control member configured in this way has particularly favorable characteristics. The piston face is preferably formed by a surface of a control piston which is arranged so as to be movable and, in particular, displaceable in the piston chamber. The resilience space of the piston chamber may be arranged between the piston face and the piston assembly. This allows the gas volume in the resilience space to be varied (for example, in relation to a minimum gas volume or a maximum gas volume) by the control piston and, in this way, the resilient properties of the resilience space and thus the returning force to be altered. Furthermore, the direction of movement of the piston assembly and the direction of displacement of the control piston may extend parallel to each other and, for example, parallel to an axis of symmetry of the piston chamber.

It is expedient for at least one position sensor to be provided, which interacts with the at least one control member. In this way, information is obtainable on the position of the at least one control member. It may be provided that the position sensor is arranged on the piston chamber. It is also conceivable for it to be arranged directly on the control member. For example, the position sensor may be configured as optical or mechanical sensor.

The at least one position sensor is preferably so configured that the position of the at least one control member relative to the at least one piston chamber is detectable. In particular, this allows checking of the position of the control member relative to the piston chamber. Since the piston chamber comprises the resilience space, it is, in this way, also possible to check the position of the control member in relation to the resilience space.

For a similar reason, i.e., preferably to check a movement of the control member, it is expedient for the at least one position sensor to be so configured that a movement of the at least one control member is detectable.

A control device is preferably provided, by means of which the free-piston device is controllable. For example, the injection of fuel into the expansion space, the point in time at which fuel is ignited in the expansion space, and valves arranged at the expansion space for intake of air or discharge of exhaust gases can be controlled by the control device.

It is expedient for the returning force to be controllable by means of the at least one control member via the control device. For example, this allows use of only one control device for the free-piston device.

It is particularly expedient for the returning force to be controllable in accordance with a signal of a position sensor. This constitutes a simple form of controlling the returning force. The position sensor can provide the control device with, for example, information on the position and/or a movement of the control member of the free-piston device. For example, this allows a drive to be activated via the control device in order to move the control member or to stop an existing movement. The resilient properties of the resilience space and, therefore, also the returning force can thereby be influenced, in particular, controlled.

At least one pressure sensor is preferably arranged at the resilience space. This allows the pressure in the resilience space, i. e., the pressure of the gas contained in the resilience space to be measured. For example, the pressure sensor can be arranged at an end face, in particular, on an end wall, of the piston chamber. A relationship exists between the pressure of the gas in the resilience space and the returning force exerted by the gas on the piston assembly. Therefore, a statement can also be made on the returning force by means of the measurement signal of the pressure sensor.

It is expedient for the at least one pressure sensor to be so configured that the pressure in the resilience space is measurable with it in a time-resolved manner. The change in the pressure in the resilience space can, therefore, also be determined. In this way, the change in the returning force can also be determined.

It is advantageous for an electric linear drive to be provided. Electric energy can thus be generated by means of the free-piston device. The electric linear drive can also be used to control the movement of the piston assembly, as is described in DE 102 19 549 B4, to which reference is explicitly made.

In particular, the at least one piston assembly preferably comprises an armature, and a stator device is preferably arranged on the at least one piston chamber. The armature is magnetized. An electric voltage is induced in the stator device by movement of the piston assembly. Accordingly, the piston assembly can be acted upon by current acting on the stator device.

In particular, it is expedient for the piston stroke to be variably settable via the linear drive in such a way that the dead centers of the movement of the at least one piston assembly are definable. This is described in DE 102 19 549 B4, to which reference is explicitly made.

In accordance with the invention, the free-piston device, in particular, the movement of the at least one piston assembly in the at least one piston chamber, is adjustable in a simple way during operation.

In accordance with an embodiment of the invention, the returning force is controlled while the free-piston device is in operation by the target value of at least one state variable of the gas in the resilience space being prescribed, and by the actual value of the at least one state variable being detected and, if it deviates from the target value, being adjusted at least approximately to the target value.

The method according to the invention has the advantages already explained in conjunction with the free-piston device according to the invention.

In particular, the returning force is controlled while the free-piston device is in operation. In this way, the free-piston device, in particular, the movement of the (at least one) piston assembly in the (at least one) piston chamber, is adjustable without interrupting operation of the free-piston device.

As mentioned above in conjunction with the explanation of the free-piston device according to the invention, a relationship exists between the returning force exerted by the gas and the pressure of the gas. The gas pressure represents a state variable of the gas. Further preferred state variables of the gas are, for example, the temperature, the volume, and the number of particles in the gas, which is linked to the mass of the gas. A relationship exists between each of these and the gas pressure via the equation of state of a gas. Thus, the temperature, the volume and the mass of the gas can, for example, also be related to the returning force exerted by the gas on the piston assembly.

In the method according to the invention, the actual value of at least one state variable is detected and adjusted at least approximately to a prescribable target value of at least one state variable. Via the relationship between the returning force and at least one state variable of the gas, it is, in this way, possible to control the returning force by the actual value of at least one state variable being controlled.

It is particularly expedient for the pressure in the resilience space to be measured in a time-resolved manner. The pressure in the resilience space corresponds to the pressure of the gas in the resilience space. The pressure is a state variable whose target value is prescribable. By time-resolved measurement of the pressure it is possible to determine whether the actual value of the pressure deviates from the target value.

It is possible for at least one control member to be moved. In particular, it may preferably be provided that a piston is displaced. By means of the movement of at least one control member or a piston it can, for example, be possible to so displace gas in the resilience space that its pressure is thereby altered. In this way, the returning force is also alterable.

The position of the at least one control member or of the piston is preferably measured in a time-resolved manner. This makes it possible, for example, to relate a pressure or a change in the pressure of the gas quantitatively to the position or a movement of the at least one control member or of the piston.

In a preferred method, the returning force is controlled via the setting of the mass of gas in the resilience space. The mass of gas can thereby be increased or reduced. It is clearly linked to the number of particles in the gas, which is a state variable of the gas.

It is equally expedient for the returning force to be controlled via the setting of the amount of gas in the resilience space. The amount of gas can be related, for example, via the gas density to the mass of gas, which, in turn, is linked to the number of particles in the gas.

It is particularly expedient for gas to be fed to the resilience space or for gas to be discharged from the resilience space. This allows the mass of gas and/or the amount of gas in the resilience space to be set in a technically simple way.

In particular, preferably at least one valve is actuated. By actuating the at least one valve it is, for example, possible to open a gas line so that gas is fed to the resilience space or discharged from it. It is thus possible to set the mass of gas and/or the amount of gas and the state variable linked to these variables, namely the number of particles in the gas.

It is quite particularly preferred when the pressure in the resilience space is controlled by means of a position of at least one control member and/or of a piston and/or by means of a position of at least one valve. In this way, the pressure can be controlled in a technically particularly simple way.

As explained above, it is, for example, possible to move or displace at least one control member or a piston, the movement or displacement being detectable by means of a position sensor. During the movement or displacement, gas can be displaced in the resilience space so that its pressure can thereby also undergo change.

As mentioned, the state variables of a gas are not independent of one another but are linked to one another by the equation of state of the gas. For example, the pressure of a gas is proportional to the mass of the gas and inversely proportional to the amount of the gas. This makes it possible to express the mass of the gas and/or the amount of the gas by the gas pressure. If a valve arranged at the resilience space is actuated, then the mass of the gas and/or the amount of the gas in the resilience space and, consequently, also the pressure in the resilience space are variable.

In the ways described above, the pressure in the resilience space is controllable in a technically simple way by means of the position of the valve and/or by means of the position of at least one control member or a piston.

When the free-piston device is operated periodically, the returning force is preferably controlled on a time scale greater than one operating cycle. This reduces the technical expenditure for carrying out such controlling. The returning force is preferably controlled over at least three operating cycles.

The following description of preferred embodiments of the invention serves in conjunction with the drawings to explain the invention in greater detail.

### BRIEF DESCRIPTION OF THE DRAWINGS

FIG. 1: shows a schematic representation of an embodiment of a free-piston device according to the invention, partly in sectional representation;

FIG. 2: shows a schematic representation of a free-piston device for performing the method according to the invention; and

FIG. 3: shows a schematic pressure-time diagram for a compression space of a free-piston device in accordance with FIG. 1 or FIG. 2.

### DETAILED DESCRIPTION OF THE INVENTION

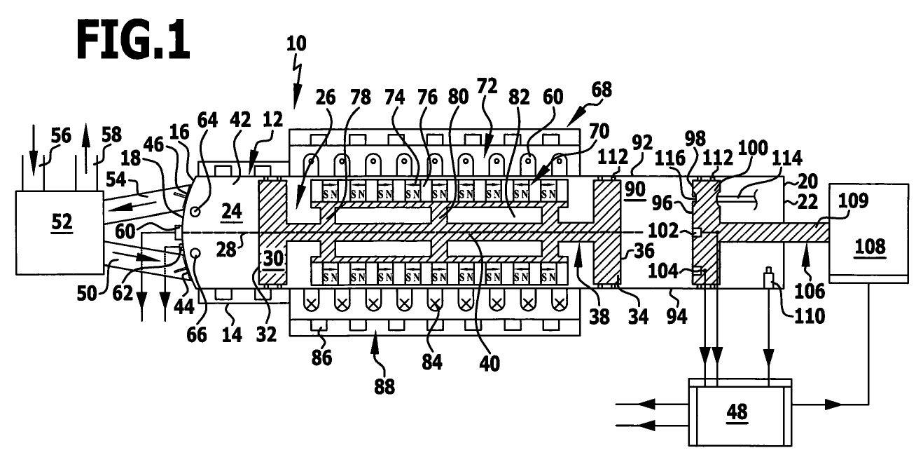

An embodiment of a free-piston device, in particular, a free-piston combustion device, according to the invention, which is shown in FIG. 1 and designated therein by 10, comprises as piston chamber 12 a cylinder with a cylinder housing 14. The cylinder housing 14 has a first end wall 16 which forms a first end face 18 of the piston chamber 12. Opposite the first end wall 16, the piston chamber 12 is delimited by a second end wall 20 which forms a second end face 22 of the piston chamber 12.

A piston assembly 26 is positioned for linear displacement in an interior 24 of the cylinder housing 14. At least with respect to its outer design, the piston assembly 26 is essentially rotationally symmetrical in relation to an axis 28 of the cylinder housing 14. The direction of the movement of the piston assembly 26 is parallel to or coaxial with this axis 28.

The piston assembly 26 comprises a first piston 30 with a first piston face 32 which faces the first end face 18. The piston assembly 26 further comprises a second piston 34 which is spaced from the first piston 30 and has a second piston face 36 which faces the second end face 22 of the piston chamber 12. The second piston 34 essentially serves to support the first piston 30. The two pistons 30, 34 are fixedly and, in particular, rigidly connected to each other by a holding structure 38. A pair of pistons is thereby formed by the piston assembly 26.

The holding structure 38 comprises, for example, a piston rod 40.

An expansion chamber with an expansion space 42 is formed between the first end face 18 of the piston chamber 12 and the first piston 30. In particular, the expansion chamber is a combustion chamber, and the expansion space is a combustion space.

(It is, in principle, also possible for a heat transfer medium such as steam, which was generated outside the expansion space or to which energy was supplied outside the expansion space, to expand in the expansion space. An example of a corresponding free-piston device is disclosed in DE 102 19 549 B4, to which reference is explicitly made.)

A medium is expandable in the expansion space 42 in order to drive the piston assembly 26 in its linear movement. In the example of a combustion space, combustion gases are the expanding medium. In particular, these are generated by a combustion process in the expansion space 42.

The dimensions of the expansion space 42 are determined by the piston stroke of the piston assembly 26, i. e., the volume and the (inside) surface of the expansion space 42 are determined by the position of the first piston 30.

One or more, in particular, electrically controllable, inlet valves 44 and one or more, in particular, electrically controllable, outlet valves 46 are associated with the expansion space 42. The (at least one) inlet valve 44 and the (at least one) outlet valve 46 are controlled by a control device 48. The intake of air and the discharge of, in particular, combustion products can be specifically controlled with respect to time via the inlet valve 44 and the outlet valve 46.

For example, a suction line 50 leading into the expansion space 42 is connected to a charger 52. The suction line 50 can be opened or closed by means of the (at least one) inlet valve 44.

An exhaust gas line 54 leads via the outlet valve 46 to the charger 52. The charger 52 itself has an inlet 56, in particular, for intake air and an outlet 58 for exhaust gases.

The charger 52 may, for example, be a compression wave charger in which the energy of the flow of exhaust gas from the expansion space 42 is used to compress the charge air (drawn-in air). With such a compression wave charger, compression waves and suction waves of the pulsating exhaust gases draw in fresh air and compress it. This compression takes place in direct contact with the exhaust gases.

For example, a constantly oscillating displacement movement of the piston assembly 26 takes place during operation of the free-piston device 10. A constant oscillation of the discharged exhaust gases is thereby achievable, so that the gas exchange is controllable via the charger 52. The advantage of a compression wave charger is that it has only a low energy expenditure.

Owing to the constant period for the oscillating movement of the piston assembly 26, the entire system of the charger 52 of the piston assembly 26 with the expansion space 42 associated with it can be precisely configured to an optimum operating point to which, in turn, the charger 52 can be configured.

In one embodiment (at least) one pressure sensor 60 is arranged at the expansion space 42. This is preferably a piezoelectric sensor. For example, the pressure sensor 60 is arranged on the first wall 16, which may have a recess in which the pressure sensor 60 is seated. The pressure sensor 60 is aligned so as to face the first piston 30. In particular, an active sensor surface faces the first piston face 32.

The pressure in the expansion space 42 can be detected via the pressure sensor 60. In particular, it may be provided that the pressure in the expansion space 42 can be determined in a time-resolved manner by the pressure sensor 60.

In addition, a temperature sensor 62 may be provided at the expansion space 42, with which the temperature in the expansion space 42 can be determined, preferably also in a time-resolved manner.

The pressure sensor 60 and the temperature sensor 62 may be connected via signal lines to the control device 48. They can thus transmit their signals to the control device 48.

Also arranged at the expansion space is an injection device 64. Fuel can be fed into the expansion space 42 via this injection device 64. During this, the injection device 64 is, for example, controllable by the control device 48.

Also arranged at the expansion space 42 is an ignition device 66, with which a fuel located in the expansion space 42 can be ignited. The ignition device 66, too, can be controlled by the control device.

The free-piston device 10 comprises an electric linear drive, designated in its entirety by 68, which comprises an armature 70. The armature 70 is arranged on the piston assembly 26. It is moved with the piston assembly 26.

In addition, the electric linear drive 68 comprises a stator device 72 which is arranged on the piston chamber 12 outside the cylinder housing 14. Via the stator device 72 voltages can be induced in order to generate electrical energy and/or the piston assembly 26 can be influenced accordingly.

The armature 70 comprises, for example, magnet elements 74 and flux conducting elements 76 which are arranged alternately between the pistons 30 and 34 on the holding structure 38.

The holding structure 38 comprises, for example, a cylindrical carrier 78 on which the magnet elements 74 and the flux conducting elements 76 are seated. The cylindrical carrier 78 is held on the piston rod 40 and, in particular, integrally connected to it. The connection is made by means of spaced bars or discs 80 extending radially. The radial direction lies perpendicularly to the direction of the axis 28. The bars or discs 80 are spaced in the axial direction 28. An intermediate space 82 is thereby formed between adjacent bars or discs 80. Therefore, the holding structure 38 is not made from a solid material, so that the mass of the piston assembly 26 is reduced in comparison with manufacture from a solid material.

The magnet elements 74 may be permanent magnet elements which, in particular, are disc-shaped and are formed rotationally symmetrically about the axis 28. In principle, they may also be electromagnet elements which comprise windings arranged correspondingly, in particular, concentrically around the axis 28. In this case, a corresponding device must be provided to enable energy to be transferred to these electromagnet elements. For example, this may occur inductively or by means of collector rings.

The flux conducting elements 76 are also disc-shaped and are made from a material of high magnetic permeability. For example, iron is used, or magnetically permeable powder composite materials are used.

The magnet elements 74, in particular, when these are permanent magnet elements, and the flux conducting elements 76 are constructed so as to have a central opening with which they can be pushed onto the carrier 78 when manufacturing the piston assembly 26.

The magnet elements 74 are constructed and, in particular, magnetized in such a way that the lines of flux of the adjacent magnet elements 74 are concentrated in a flux conducting element 76 in order to thereby increase the magnetic power density of the system. In particular, the magnet elements 74 are arranged in parallel in such a way that like poles of adjacent magnet elements 74 face each other.

It may also be provided that an outer surface of the armature 70 is constructed in such a way that it is tooth-shaped in a cross section, comprising the axis 28, of an inner side facing a cylinder wall. Owing to such a tooth structure, the armature 70 has alternating magnetic conductivities, via which a propulsion can be generated for the piston assembly 26.

The stator device 72 comprises main ring windings 84 which are arranged outside the cylinder housing 14 so as to surround it. Upon relative movement of the magnetized armature 70, a voltage is induced in these main ring windings 84, and electrical energy can be coupled out. A current-generating device is thereby provided, which is based on the principle of free-piston guidance (linear movability of the piston assembly 26).

The stroke of the piston assembly 26 is controllable by the control device 48. In particular, such a controlling can be carried out such that at any point in time the location of the piston assembly 26 is fixed. Therefore, if required, the reversal point of the piston movement of the first piston 30 can be set so as to be able, in turn, to set the dimensions of the expansion space 42. By correspondingly controlling the linear drive 68, the piston stroke can thus be set in dependence upon the load state. Furthermore, the compression can be set, and the speed of the piston assembly 26 can be set. This makes it possible to set the expansion space 42 optimally (with respect to volume and surface as well as change in volume and change in surface) depending on the load state. In particular, the volume of the expansion space 42 and the respective surface of the expansion space 42 can thereby be adapted to the application.

By setting the piston stroke with respect to time and location (position, compression, speed) an adaptation to the fuel that is used can also be carried out, i. e., a piston stroke and compression can be set, depending on whether, for example, a fuel such as diesel or vegetable oil is used with self-ignition or a fuel such as gasoline, natural gas or hydrogen is used as fuel with ignition by an ignition device.

By specifically prescribing currents in the stator device 72 and optionally in the armature 70, i. e., by controlling these currents, the piston assembly 26 can be influenced in its linear displaceability so as to enable precise fixing of the location of the reversal points of the piston movement of the piston assembly 26 for the expansion space 42.

Thus, a correspondingly large piston stroke can be set, for example, under full load, when a large intake amount of air is required for the expansion space 42 if combustion is to take place therein, whereas a reduced stroke can be set for partial-load operation with a reduced intake volume.

It may also be provided that one or more secondary windings are arranged around the cylinder housing 14. These are electrically separate from the main ring windings 84 of the stator device 72. For example, the secondary windings are arranged around the main ring windings 84, i. e., they surround these. They may also be arranged alongside main ring windings 84 (in particular, in an axial extension of a ring winding axis of the main ring windings 84).

Via such secondary windings a further current can be coupled out, in order, for example, to supply a 12 V/14 V or a 36 V/42 V electrical system of a motor vehicle with power. The number of windings of the secondary windings is adapted accordingly. Such secondary windings are preferably followed by a rectifier so as to be able to generate a rectified current.

It may also be provided that a cooling device 88 comprising cooling ducts 86 is arranged around the stator device 72 in order to cool the active components of the free-piston device 10 (with linear drive 68). In particular, the piston assembly 26, the piston chamber 12 and the main ring windings 84 are among these active components.

It may also be provided that heat is coupled out of the corresponding cooling device 88 in order to use it in thermal applications, for example, for a vehicle heater or for a block-type thermal power station.

A compression space in the form of a resilience space 90 is formed between the second piston 34 of the piston assembly 26 and the second end face 22 of the piston chamber 12. The resilience space 90 does not occupy the total volume of the cylinder housing 14 between the second piston face 36 and the second end wall 20. The resilience space 90 is delimited by the second piston face 36, the walls of the cylinder housing 14 along wall areas 92 and 94 and by a wall section 96 formed by a piston face 98 of a control piston 100.

The piston face 98 comprises the entire wall section 96 of the resilience space 90. It forms a control member of the free-piston device 10, whose mode of operation will be explained hereinbelow.

The piston face 98 is positioned between the second piston face 36 and the second end wall 20 of the piston chamber 12. It lies opposite the second end face 22 and, in particular, is orientated parallel to the second end wall 20. In this way, the piston face 98 delimits the resilience space 90 at an end side, in relation to its alignment inside the cylinder housing 14.

The resilience space 90 is formed in the piston chamber 12 between the second piston 34 of the piston assembly 26 and the control piston 100, and delimited in the longitudinal direction of the piston chamber 12 by the second piston face 36 of the second piston 34 and the piston face 98 of the control piston 100.

A compressible fluid, in particular, a gas such as, for example, air is contained in the resilience space 90.

The gas in the resilience space 90 can at least partially “elastically” absorb mechanical energy which was not coupled out by the linear drive 68 during an expansion cycle of the piston assembly 26. This occurs by compression of the gas by the piston assembly 26.

Conversely, the gas in the resilience space 90 can expand and in this way drive back the piston assembly 26. The stored energy can, therefore, be used to compress the fuel-air mixture in two-cycle operation or to eject the exhaust gases in four-cycle operation if combustion takes place in the expansion space 42 to produce the expanding medium.

The gas in the resilience space 90, therefore, forms a gas spring which can absorb mechanical energy of the piston assembly 26 with high reversibility and by means of expansion can release energy to the piston assembly 26.

Arranged at the resilience space 90 is a pressure sensor 102, which is arranged on the piston face 98 of the control piston 100. For this purpose, the piston face 98 has, for example, a recess in which the pressure sensor 102 is arranged.

The pressure sensor 102 faces the second piston face 36 of the second piston 34, in particular, with an active sensor surface.

In a variant of this embodiment, the pressure sensor may, for example, be arranged on one of the wall areas 92 or 94 between the second piston face 36 and the piston face 98.

The pressure in the resilience space 90 can be measured with the pressure sensor 102. In particular, the pressure can be measured in a time-resolved manner by the pressure sensor 102. The pressure sensor 102 is preferably a piezoelectric sensor.

In addition, there may be arranged at the resilience space 90 a temperature sensor 104, which, for example, may be arranged similarly to the pressure sensor 102 in a recess of the piston face 98 of the control piston 100.

The temperature in the resilience space 90 is measurable by means of the temperature sensor 104.

The pressure sensor 102 and the temperature sensor 104 can transmit their measurement signals via signal lines to the control device 48.

The control piston 100 is movably mounted in the piston chamber 12, in particular, it is mounted for linear displacement therein. In this way, the piston face 98 is movable and, in particular, linearly displaceable by means of the control piston 100 in the cylinder housing 14. The direction of the displacement is parallel to or coaxial with the axis 28 and parallel to the direction of displacement of the piston assembly 26.

This makes it possible to alter the gas volume in the resilience space 90 to set the returning force of the gas spring. The minimum and the maximum gas volume can be altered, and, in particular, set in a defined manner. The gas volume is at minimum when the piston assembly 26 is at its top dead center OT in relation to the piston face 98, and it is at maximum when the piston assembly 26 is at its bottom dead center UT in relation to the piston face 98.

A drive device 108 is associated with the control piston 100. For this purpose, the control piston 100 is connected via a holding device 106 to the drive device 108. The holding device 106 comprises, for example, a piston rod 109, which may pass through the second end wall 20 of the piston chamber 12. The holding device 106 may be of rigid construction, whereby the control piston 100 can be moved and, in particular, linearly displaced in the piston chamber 12 by the drive device 108.

The drive device 108 comprises, for example, a hydraulic system for moving the control piston 100. Also conceivable are a pneumatic drive and/or an electric drive.

The control device 48 is connected via a control line to the drive device 108, so that it is activatable and, in particular, controllable by the control device 48. In this way, the position of the control piston 100 is, for example, prescribable by the control device 48.

The free-piston device 10 comprises a position sensor 110, with which the position of the holding device 106 relative to the piston chamber 12 is detectable. In this way, the position and a movement of the control piston 100 and, therefore, also of the piston face 98 are detectable by the position sensor 110.

The position sensor 110 is, for example, arranged close to the second end wall 20 of the cylinder housing 14, and an active sensor surface can be aligned in the direction of the holding device 106. The position sensor 110 can transmit its measurement signal via a signal line to the control device 48.

Also conceivable is an arrangement of the position sensor 110, for example, on the piston face 98, with an active sensor surface facing the second piston face 36. In this case, the position sensor may, for example, be configured as an optical sensor.

Also conceivable is a mechanically operating position sensor which, for example, is mechanically coupled to the holding device 106. The position sensor 110 may also be integrated into the drive device 108.

The resilience space 90 is closed off in a gas-tight manner. The second piston 34 of the piston assembly 26 and the control piston 100 comprise for this purpose seals 112, for example, in the form of polymer seals. These ensure a high tightness of the resilience space 90 even at high pressures of the gas in the interior.

In one embodiment, a gas line 114 is arranged on the control piston 100 and may, for example, be led in a bore of the control piston 100. The gas line 114 has an opening 116 arranged on the piston face 98.

It may be provided that the gas line 114 can be opened and closed in a defined manner by a valve not shown in the drawings. The resilience space 90 may then be, for example, in fluid-operative connection with a gas storage unit not shown in the drawings.

The gas line 114 may be configured as filler line for the resilience space 90. This makes it possible to keep the amount of gas in the resilience space 90 constant.

In addition, it is thus possible to fill the resilience space 90 for the first time with gas when assembling the free-piston device 10.

Further examples of free-piston devices are disclosed in DE 102 19 549 B4 and in EP 1 398 863 A1. Reference is explicitly made to these publications.

The free-piston device 10 according to the invention operates as follows:

Certain reversal points (top dead center OT and bottom dead center UT) of the piston assembly 26 are set via the linear drive 68 by the corresponding action of current, in order to specify the volume and the surface of the expansion space 42 and, in particular, of a combustion space. Furthermore, the speed of the piston assembly 26 is fixed and, in total, the compression. This setting is carried out in dependence upon the load (partial load or full load), the fuel (gasoline, natural gas, hydrogen, diesel, vegetable oil, etc.) and any further external parameters.

It may be provided that an electric preheating is carried out for starting the free-piston device 10 and that the cooling water of the cooling device 88 is also preheated. This preheating may be carried out via the linear drive 68 by corresponding windings, for example, the main ring windings 84 being used as heating elements. Heating coils of its own may, however, also be provided.

The pair of pistons with pistons 30 and 34 provides a support for the piston assembly 26, i. e., the pistons 30, 34 can be linearly guided in a substantially tilt-free manner in the piston chamber 12. The pistons 30, 34 also serve to seal off the expansion space from the resilience space 90.

The reversal points of the movement of the piston assembly 26 can be precisely specified with respect to location and time by the linear drive 68. Therefore, in partial-load operation, there is also no necessity for a throttle valve for air intake, which is otherwise responsible for throttling losses.

The intake of air and the discharge of exhaust gases can be controlled in a specific manner by the inlet valve 44 and the outlet valve 46 for the expansion space 42. The efficiency of the entire system and the quality of the exhaust gas can thereby be improved. By precise setting of the control times via points in time and of the duration with respect to the gas exchange (flow through the inlet valve 44 and through the outlet valve 46) an exact adaptation can take place between the individual time-critical procedures. Since the speed of the piston assembly 26 is also controllable, during the expansion procedure, too, the development of the exhaust gases can be influenced.

In particular, the inlet valve 44 is arranged and constructed such that drawn-in air and resulting flows of gas are guided along inside cylinder walls so as to obtain an optimized flushing procedure for a gas exchange.

It is preferable for air to be drawn in and compressed and for exhaust gases to be discharged via the charger 52.

It may be provided that the ignition of the medium in the expansion space 42 can be controlled by the control device 48 in accordance with the signal of one of the pressure sensors 60 or 102.

In particular, the valves 44, 46, the injection device 64 and/or the ignition device 66 can be controlled and regulated. This controlling can be carried out such that a substantially stoichiometric combustion is possible in the expansion space 42. Such controlling is disclosed, for example, in DE 10 2004 062 440 B4 of the same applicant, to which reference is explicitly made.

During the movement of the piston assembly 26, on account of the relative movement between the armature 70 and the stator device 72 a voltage is induced in the latter, so that electric energy is generated: mechanical energy is partly converted into electrical energy, with the mechanical energy originating, in turn, from a partial conversion of chemical energy as a result of the combustion.

Energy which is not coupled out by the linear drive 68 during the combustion cycle when combustion takes place in the expansion space 42 can be absorbed by the resilience space 90. In accordance with the invention, it is made possible for the properties of the resilience space 90 to be set such that an optimum operating point is obtained even in the event of fluctuations with respect to time. This will be explained in detail hereinbelow.

The stator device 72 is cooled by the cooling device 88. The cooling device 88 may also cool further parts of the piston chamber 12 and, for example, the piston assembly 26.

The pistons 30, 34 are, for example, lubricated by a simple splash lubrication, so that an oil pump is not required. The pistons 30, 34 then move in an oil bath which is whirled around by the movement so as to ensure adequate provision with lubricating oil.

The pistons 30, 34 can be manufactured with a minimized side face facing the cylinder housing 14, i. e., piston skirts can be of short configuration as the pair of pistons with the first piston 30 and the second piston 34 ensures a mutual supporting effect. Frictional losses during the movement of the piston assembly 26 can thereby be minimized.

In turn, it is then possible to also manufacture the pistons 30, 34 from non-metallic materials such as ceramic materials or from graphite or, for example, glass fiber-reinforced carbon materials. Such pistons can do without lubrication.

Owing to the armature 70 with alternately arranged magnet elements 74 and flux conducting elements 76, a high magnetic power density of the system is achievable. In particular, high power densities are achievable when the pole pitch in the armature 70 and the stator device 72 is different.

As mentioned above, the gas in the resilience space 90 can absorb mechanical energy from the piston assembly 26 by being compressed by the latter. In this case, the second piston 34 of the piston assembly 26 exerts on the gas in the resilience space 90 a force by means of which the gas is compressible by the piston assembly 26.

Conversely, the gas in the resilience space 90 can release energy to the piston assembly 26 by expanding and driving the piston assembly 26 in the direction of the end face 18 of the piston chamber 12. In this case, too, a force acts between the gas and the second piston 34 of the piston assembly 26.

As a result of its gas pressure p, the gas in the resilience space 90 is then exerting at all times a returning force F on the piston assembly 26, which is counteracting the compression by the piston assembly 26.

The returning force F exerted by the gas is, for example, proportional to the pressure p of the gas. The proportionality constant is the area A on which the returning force F acts. The returning force F can therefore be represented as product p·A. This relationship between the returning force F and the gas pressure p allows the returning force F exerted by the gas on the second piston 34 to be expressed by the gas pressure p. The gas pressure p then corresponds to the internal pressure of the resilience space 90.

As mentioned above, the free-piston device 10 comprises the controlling member formed by piston face 98, with which the returning force F is controllable. The piston face 98 forms a wall section 96 delimiting the resilience space.

In accordance with what has been stated above, the returning force F is, for example, controllable by the gas pressure p in the resilience space 90 being controllable.

The gas pressure p can be varied by the gas volume being set and, in particular, by the minimum and the maximum gas volume being set by movement and/or positioning of the control piston 100 and, therefore, in particular, of the piston face 98 in the piston chamber 12.

The gas pressure p can be measured by the pressure sensor 102 and communicated to the control device 48. For example, the oscillation frequency of the piston assembly 26 during operation of the free-piston device 10 lies in the order of magnitude of 50 Hz. When a piezoelectric sensor is used for the pressure sensor 102, the necessary response time can be achieved for also measuring the gas pressure p with sufficient accuracy in a time-resolved manner.

The control piston 100 and the control member formed by piston face 98 can be moved and, in particular, displaced by the drive device 108. In this way, the gas pressure p in the resilience space 90 is alterable.

It may be provided that the control device 48 provides the drive device 108 with a control signal dependent upon the gas pressure p. The drive device 108 can then bring about the movement of the control piston 100 in dependence upon the signal provided. In this way, the movement of the control piston is controllable and, consequently, the gas pressure p in the resilience space 90 is controllable.

The position of the holding device 106 and, in this way, the position and/or the movement of the piston face 98 with respect to the piston chamber 12 can be detected by the position sensor 110. The measurement signal of the position sensor 110 can be communicated to the control device 48. This offers the possibility of constructing a control loop in which the gas pressure p is regulated in dependence upon the position and/or movement of the control piston 100.

Because the gas pressure p of the gas in the resilience space 90 is controllable, the returning force F exerted by the gas on the piston assembly 26 is, consequently, also controllable.

In particular, it is possible with the free-piston device 10 according to the invention to carry out the controlling of the returning force F while the free-piston device 10 is in operation.

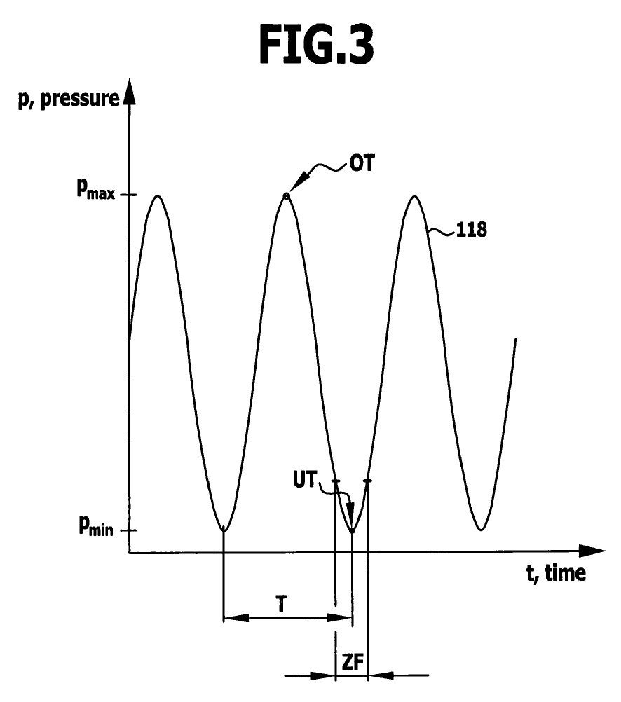

A schematic pressure-time diagram for the gas pressure p in the resilience space 90 is shown in FIG. 3. The gas pressure p in the resilience space 90 is represented schematically by the curve 118. The gas pressure p oscillates in accordance with the oscillating movement of the piston assembly 26 between a maximum pressure pₘₐₓ and a minimum pressure pₘᵢₙ with a period T. The maximum pressure pₘₐₓ is reached at the top dead center OT of the piston assembly 26 in relation to the piston face 98, and the minimum pressure pₘᵢₙ is reached at the bottom dead center UT of the piston assembly 26 in relation to the piston face 98.

For example, it is possible to displace the control piston and the piston face 98 only within a time slot ZF, which in terms of time is located in the area of the bottom dead center UT. In this case, the piston assembly 26 is furthest from the piston face 98, and the control piston 100 is movable with the least force expenditure.

The controlling of the returning force F exerted by the gas in the resilience space 90 on the piston assembly 26 allows the movement of the piston assembly 26 to be adjusted. This makes it possible to set an optimum operating point of the free-piston device 10. At this optimum operating point, for example, the fuel requirement and/or the discharge of pollutions can be minimized.

Expediently, the regulating of the gas pressure p is carried out over several, preferably at least three, periods T of the oscillation movement of the piston assembly 26. This reduces the technical requirements to be met by the components of the free-piston device 10.

In a variant of this embodiment, it may be provided that not an entire wall delimiting the resilience space 90 is moved. It is, for example, conceivable for only a certain wall section of a wall delimiting the resilience space 90 to move in order to displace the gas in the resilience space 90.

With the free-piston device 10 it is possible to perform a method according to the invention, wherein the returning force F is controlled while the free-piston device 10 is in operation, the target value of at least one state variable of the gas in the resilience space 90 being prescribable, and wherein the actual value of the at least one state variable is detected, and, if it deviates from the target value, is adjusted at least approximately to the target value.

The performance of the method has already been explained above in the description of the mode of operation of the free-piston device 10.

The gas pressure p in the resilience space 90 whose target value may be prescribed so that a certain operating point of the free-piston device 10 is achievable is used as state variable of the gas. If the actual value of the gas pressure p deviates from the target value, then the control device 48 can activate the drive device 108, whereby the gas pressure p in the resilience space 90 is controllable, as described above.

The target value of the gas pressure p may, for example, be defined as an average pressure during operation or as a pressure at fixed points in time of operation of the free-piston device 10, for example, the pressure pₘₐₓ at the top dead center OT or the pressure pₘᵢₙ at the bottom dead center UT (FIG. 3).

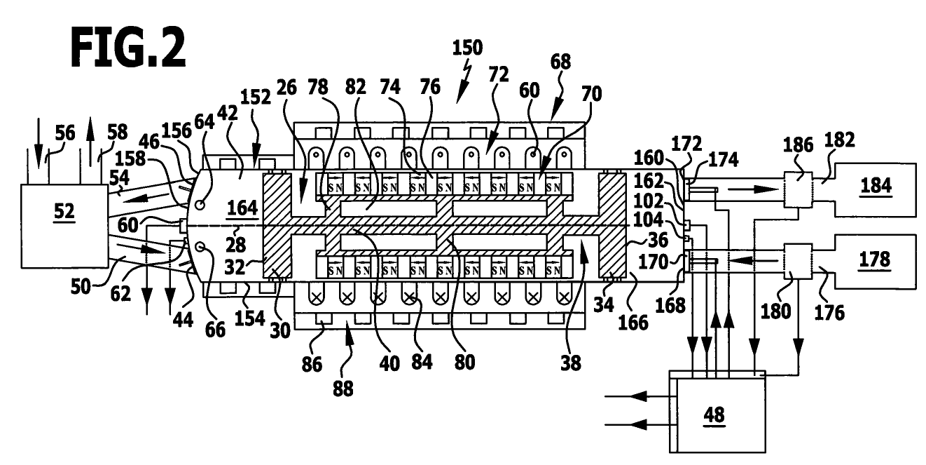

A further free-piston device for performing the method according to the invention is denoted in its entirety in FIG. 2 by reference numeral 150. In principle, like components as in embodiment 10 are denoted by like reference numerals.

In the free-piston device 150, the piston assembly 26 is displaceably arranged in a piston chamber 152. The piston chamber 152 is formed by a cylinder housing 154. The cylinder housing 154 has a first end wall 156 which forms a first end face 158 of the piston chamber 152. Opposite the first end wall 156 is a second end wall 160 which forms a second end face 162 of the piston chamber 152.

The piston assembly 26 is positioned in an interior 164 of the cylinder housing 154.

A compression space in the form of a resilience space 166 is formed between the piston face 36 of the piston 34 and the end wall 160. A compressible fluid, in particular, a gas such as, for example, air is contained in the resilience space 166.

The gas can be compressed by the movement of the piston assembly 26 and thereby absorb at least partially “elastically” energy which during an expansion cycle was not coupled out by the linear drive 68. In a corresponding manner, the gas in the resilience space 166 can release the energy by, for example, expanding and driving the piston assembly 26 in the direction of the end wall 156.

The pressure sensor 102 is arranged at the resilience space 166. For example, it is arranged on the second end wall 160. For this purpose, the second end wall 160 may have a recess in which the pressure sensor 102 is arranged. In particular, an active sensor surface can face the piston face 36 of the piston 34.

The pressure in the resilience space 166 is measurable and, in particular, measurable in a time-resolved manner by the pressure sensor 102.

It may be further provided that the temperature sensor 104 is arranged at the resilience space 166. The temperature in the resilience space 166 is detectable by the temperature sensor 104.

The second end wall 160 has at least one opening at which at least one valve is arranged. In particular, the end wall 160 has a first opening 168 having associated with it an inlet valve 170, and a second opening 172 having associated with it an outlet valve 174.

The first opening 168 of the resilience space 166 can be opened and closed by the inlet valve 170, and, in a corresponding manner, the second opening 172 of the resilience space 166 can be opened and closed by the outlet valve 174.

The inlet valve 170 and the outlet valve 174 may be controlled in a defined manner with respect to time by the control device 48.

The inlet valve 170 and the outlet valve 174 may be magnetically and/or electrically and/or mechanically actuatable. In particular, these may be valves with a short switching time, preferably up to a few milliseconds. Valves with a switching time of a few milliseconds are manufactured, for example, by the company “Lotus Engineering”.

A gas line, in particular, a feed line 176 leads via the inlet valve 170 to a gas reservoir, for example, a gas storage unit 178. When the inlet valve 170 is open, there can therefore be a fluid-operative connection between the resilience space 166 and the gas storage unit 178 through the feed line 176.

A gas amount sensor in the form of a volumetric flow rate sensor 180 is arranged in the feed line 176. With the volumetric flow rate sensor 180 it is possible to detect an amount of gas flowing through the feed line 176. The volumetric flow rate sensor 180 can communicate its measurement signal to the control device 48 via a signal line.

It may be provided that the gas pressure in the gas storage unit 178 is greater than the gas pressure p in the resilience space 166. In this way, the opening of the inlet valve 170 can cause a certain amount of gas to flow from the gas storage unit 178 through the feed line 176 into the resilience space 166. This flow of gas results from the pressure gradient between the gas pressure p in the resilience space 166 and the pressure in the gas storage unit 178. This amount can be detected by the volumetric flow rate sensor 180 and communicated to the control device 48.

A gas line, in particular, a discharge line 182 leads via the outlet valve 174 from the resilience space 166 to a gas reservoir, for example, a gas storage unit 184. Therefore, when the outlet valve 174 is open, there can be a fluid-operative connection between the resilience space 166 and the gas storage unit 184 through the discharge line 182.

It may be provided that a volumetric flow rate sensor 186, which can detect an amount of gas flowing through the discharge line 182, is arranged in the discharge line 182. In particular, the volumetric flow rate sensor 186 can communicate its measurement signal via a signal line to the control device 48.

It is possible that the gas pressure in the gas storage unit 184 is lower than the pressure in the resilience space 166. Upon opening the outlet valve 174, a certain amount of gas flows on account of the pressure gradient from the resilience space 166 through the discharge line 182 to the gas storage unit 184. The amount of gas can be detected by the volumetric flow rate sensor 186 and communicated to the control device 48.

It is thus possible to discharge gas from the resilience space 166 or to feed gas to the resilience space 166 by opening the inlet valve 170 or the outlet valve 174. This allows the mass of gas and/or the amount of gas in the resilience space 166 to be set by increasing or decreasing the mass of gas and/or the amount of gas.

For example, more gas can be fed to the resilience space 166 so that the mass of gas and the amount of gas in the resilience space 166 increase. Conversely, gas can be discharged from the resilience space 166 so that the mass of gas and the amount of gas in the resilience space 166 decrease.

A variant of the free-piston device 150 comprises only one valve arranged at the resilience space 166, after the opening of which gas can be fed to or discharged from the resilience space 166.

The method according to the invention may be performed with the free-piston device 150 as follows:

As explained above, the returning force F exerted by the gas in the resilience space 166 on the piston assembly 26 is proportional to the gas pressure p in the resilience space 166. The returning force F can be expressed via this relationship using the gas pressure p.

In particular, it is possible to control the returning force exerted by the gas on the piston assembly 26 by the gas pressure p in the resilience space 166 being controlled.

The pressure p in the resilience space 166 is a state variable of the gas. Its target value is prescribable and can, for example, be specified by a desired operating point of the free-piston device 150. The target value may be an average value, but it is also possible for it to be a pressure that is defined at fixed points in time during operation of the free-piston device 150.

The actual value of the pressure is measurable by the pressure sensor 102. The method according to the invention provides that the actual value is adjusted at least approximately to the target value.

According to the equation of state of an ideal gas, the gas pressure p is proportional to the gas mass m of the gas. This makes it possible to set the gas pressure p (for example, in relation to a fixed position of the piston assembly 26) in the resilience space 166 by means of the gas mass in the resilience space 166.

For example, the gas mass m in the resilience space 166 can be increased by opening the inlet valve 170 so that gas flows from the gas storage unit 178 through the feed line 176 into the resilience space 166. As a result, the gas pressure in the resilience space 166 increases.

The gas mass m in the resilience space 166 can be reduced by opening the outlet valve 174. Gas flows from the resilience space 166 through the discharge line 182 into the gas storage unit 184. As a result, the gas pressure p in the resilience space 166 decreases.

It may be provided that the inlet valve 170 and/or the outlet valve 174 can be opened and/or closed in a defined manner by the control device 48 in order to increase and/or decrease the gas mass m in the resilience space 166.

The gas pressure p is measurable in a time-resolved manner by the pressure sensor 102, and the measurement signal can be communicated to the control device 48. The control device 48 can open and/or close the inlet valve 170 and/or the outlet valve 174 in dependence upon the measurement signal of the pressure sensor 102. In this way, the gas mass in the resilience space 166 can be increased or reduced until the actual value of the gas pressure p in the resilience space 166 is at least proximately adjusted to the target value.

In this way, it is possible to control the gas pressure p by means of the position of the inlet valve 170 and/or of the outlet valve 174 via the control device 48.

It may also be provided that the control device 48 evaluates which gas mass m is to be fed to or discharged from the resilience space 166 upon opening the inlet valve 170 or the outlet valve 174:

The gas mass m is, for example, proportional to the amount of gas, and the proportionality factor is the gas density. The amount of gas fed or discharged can be detected by the volumetric flow rate sensors 180 and 186, respectively, and the corresponding measurement values communicated to the control device 48. This can then calculate the corresponding gas masses.

Owing to the relationship between the gas pressure p in the resilience space 166 and the returning force F exerted by the gas on the piston assembly 26 and, in particular, on the second piston 34, the returning force F is thereby also controlled. The controlling of the returning force takes place while the free-piston device 150 is in operation.

In particular, it may be provided that the setting and/or controlling only takes place at certain points in time, for example, within a time slot ZF, which considered in terms of time is located around the bottom dead center UT of the piston assembly 26 in relation to the second end wall 160 (FIG. 3). In this case, the gas pressure p in the resilience space 166 is close to its minimum pₘᵢₙ. This makes it easier to feed a certain amount of gas to the resilience space 166 or to discharge a certain amount of gas from it.

It is possible to change the state of movement of the piston assembly 26 in a defined manner by the returning force F exerted by the gas in the resilience space 166 on the piston assembly 26 and, in particular, on the second piston 34 being controlled. This allows improved adaptation of the free-piston device 150, and, in particular, setting of an optimum operating point of the free-piston device 150.

1. Free-piston device, comprising:
at least one piston chamber in which at least one piston assembly is arranged for linear displacement, the at least one piston assembly being drivable under the action of a medium which expands in an expansion space, and the at least one piston chamber having a resilience space containing a compressible gas for exerting a returning force on the at least one piston assembly; and
at least one control member for controlling the returning force, which is arranged at the resilience space;
wherein the returning force is controllable while the free-piston device is in operation.

2. Free-piston device in accordance with claim 1, wherein the at least one control member is movable.

3. Free-piston device in accordance with claim 2, wherein the at least one control member is movable in a fixable manner.

4. Free-piston device in accordance with claim 2, wherein the at least one control member is displaceable.

5. Free-piston device in accordance with claim 4, wherein the direction of displacement of the at least one control member is parallel to the direction of movement of the at least one piston assembly.

6. Free-piston device in accordance with claim 2, wherein a drive is associated with the at least one control member for movement thereof.

7. Free-piston device in accordance with claim 6, wherein the drive is controllable.

8. Free-piston device in accordance with claim 1, wherein at least one control member is formed as a wall section delimiting the resilience space.

9. Free-piston device in accordance with claim 8, wherein the wall section lies opposite an end face of the at least one piston chamber.

10. Free-piston device in accordance with claim 8, wherein the wall section is formed by a piston face.

11. Free-piston device in accordance with claim 1, wherein at least one position sensor is provided, which interacts with the at least one control member.

12. Free-piston device in accordance with claim 11, wherein the at least one position sensor is so configured that the position of the at least one control member relative to the at least one piston chamber is detectable.

13. Free-piston device in accordance with claim 11, wherein the at least one position sensor is so configured that a movement of the at least one control member is detectable.

14. Free-piston device in accordance with claim 1, wherein a control device is provided, by means of which the free-piston device is controllable.

15. Free-piston device in accordance with claim 14, wherein the returning force is controllable by means of the at least one control member via the control device.

16. Free-piston device in accordance with claim 15, wherein the returning force is controllable in accordance with a signal of a position sensor.

17. Free-piston device in accordance with claim 1, wherein at least one pressure sensor is arranged at the resilience space.

18. Free-piston device in accordance with claim 17, wherein the at least one pressure sensor is so configured that the pressure in the resilience space is measurable with it in a time-resolved manner.

19. Free-piston device in accordance with claim 1, wherein an electric linear drive is provided.

20. Free-piston device in accordance with claim 19, wherein the at least one piston assembly comprises an armature, and a stator device is arranged on the at least one piston chamber.

21. Free-piston device in accordance with claim 19, wherein the piston stroke is variably settable via the linear drive in such a way that the dead centers of the movement of the at least one piston assembly are definable.

22. Method for operating a free-piston device, comprising:
driving at least one piston assembly guided for linear displacement in at least one piston chamber under the action of a medium which expands in an expansion space; and
exerting a returning force on the at least one piston assembly by a compressible gas contained in a resilience space of the at least one piston chamber;
the returning force being controlled while the free-piston device is in operation by the target value of at least one state variable of the gas in the resilience space being prescribed, and by the actual value of the at least one state variable being detected and, if it deviates from the target value, being adjusted at least approximately to the target value.

23. Method in accordance with claim 22, wherein the pressure in the resilience space is measured in a time-resolved manner.

24. Method in accordance with claim 22, wherein at least one control member is moved.

25. Method in accordance with claim 24, wherein a piston is displaced.

26. Method in accordance with claim 24, wherein the position of the at least one control member or of the piston is measured in a time-resolved manner.

27. Method in accordance with claim 22, wherein the returning force is controlled via the setting of the mass of gas in the resilience space.

28. Method in accordance with claim 22, wherein the returning force is controlled via the setting of the amount of gas in the resilience space.

29. Method in accordance with claim 27, wherein gas is fed to the resilience space or gas is discharged from the resilience space.

30. Method in accordance with claim 27, wherein at least one valve is actuated.

31. Method in accordance with claim 22, wherein the pressure in the resilience space is controlled by means of a position of at least one control member or of a piston and/or by means of a position of at least one valve.

32. Method in accordance with claim 22, wherein when the free-piston device is operated periodically the returning force is controlled on a time scale greater than one operating cycle.
